(19) United States
(12) Patent Application Publication
(10) Pub. No.: US 2024/0144502 A1
(43) Pub. Date: May 2, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventor: KAZUNORI KAMIO, TOKYO (JP)

(21) Appl. No.: 18/548,877

(22) PCT Filed: Feb. 14, 2022
(86) PCT No.: PCT/JP2022/005576

§ 371 Date: Sep. 1, 2023

(30) Foreign Application Priority Data
Mar. 10, 2021 (JP) 2021-038353

(51) Int. Cl. G06T 7/50; G06T 5/70; G06V 10/25; G06V 10/60

(52) U.S. Cl. CPC G06T 7/50; G06T 5/70; G06V 10/25; G06V 10/60

(57) ABSTRACT

An information processing apparatus (30) includes a degradation unit (31), a restoration unit (33), and a depth estimation unit (35). The degradation unit (31) blurs a light reception image of reference light (PL) received by a light reception unit (20) on the basis of a known degradation characteristic. The restoration unit (33) restores light reception data of the reference light (PL) using a restoration characteristic that is an inverse characteristic of the degradation characteristic. The depth estimation unit (35) estimates the depth of a subject on the basis of the restored light reception data.

### FIELD

The present invention relates to an information processing apparatus, an information processing method, and a program.

### BACKGROUND

A three-dimensional measurement technique using a time of flight (ToF) method is known. In this method, reference light such as an infrared pulse is projected toward a subject, and the depth of the subject is detected on the basis of information on the time until the reflected light is received.

### CITATION LIST

### Patent Literature

Patent Literature 1: JP 2020-046247 A
Patent Literature 2: JP 2017-020841 A
Patent Literature 3: JP 2010-071976 A
Patent Literature 4: JP 2020-118478 A
Patent Literature 5: JP 2013-134173 A
Patent Literature 6: JP 2016-206026 A

### SUMMARY

### Technical Problem

The resolution of the depth is limited by a sampling period. When the sampling period is lengthened to widen a distance measurement range, the resolution of the depth decreases.

Therefore, the present disclosure proposes an information processing apparatus, an information processing method, and a program capable of enhancing the resolution of depth.

### Solution to Problem

According to the present disclosure, an information processing apparatus is provided that comprises: a degradation unit that blurs a light reception image of reference light received by a light reception unit on a basis of a known degradation characteristic; a restoration unit that restores light reception data of the reference light using a restoration characteristic, the restoration characteristic being an inverse characteristic of the degradation characteristic; and a depth estimation unit that estimates a depth of a subject on a basis of the restored light reception data. According to the present disclosure, an information processing method in which an information process of the information processing apparatus is executed by a computer, and a program for causing the computer to execute the information process of the information processing apparatus, are provided.

### BRIEF DESCRIPTION OF DRAWINGS

FIG. 1 is an explanatory diagram of a distance measurement method using a ToF camera.

FIG. 2 is a diagram illustrating the outline of measurement.

FIG. 3 is a diagram for explaining a degradation model of reference light.

FIG. 4 is a diagram for explaining a mechanism for improving depth resolution by analog degradation and restoration processing.

FIG. 5 is a diagram illustrating a saturation suppression mechanism by analog degradation.

FIG. 6 is a diagram for explaining a mechanism for improving a spatial resolution.

FIG. 7 is a diagram illustrating an example in which an iToF method is adopted.

FIG. 8 is a diagram for explaining the outline of information processing of a ToF camera.

FIG. 9 is a diagram illustrating a schematic configuration of a ToF camera.

FIG. 10 is a diagram illustrating an example of restoration processing of degraded light reception data.

FIG. 11 is a diagram illustrating an example of improving a depth map by restoration processing.

FIG. 12 is a diagram illustrating an example of improving a depth map by restoration processing.

FIG. 13 is an explanatory diagram of saturation correction.

FIG. 14 is an explanatory diagram of saturation correction.

FIG. 15 is a diagram illustrating an example of saturation correction of degraded light reception data.

FIG. 16 is a diagram illustrating an example of improving a depth map by saturation correction.

### DESCRIPTION OF EMBODIMENTS

Hereinafter, embodiments of the present disclosure will be described in detail on the basis of the drawings. In the following embodiments, the same parts are denoted by the same reference numerals, and redundant description will be omitted.

Note that the description will be given in the following order.

[1. Distance measurement method using ToF camera]

[2. Degradation model of reference light PL]

[3. Mechanism for improving depth resolution by analog degradation and restoration processing.

[4. Saturation suppression mechanism by analog degradation]

[5. Mechanism for improving spatial resolution]

[6. Outline of information processing of ToF camera]

[7. Configuration of ToF camera]

[8. Example of improvement of depth map by restoration processing]

[9. Saturation correction]

[10. Example of improvement of depth map by saturation correction]

[11. Effects]

[1. Distance Measurement Method Using ToF Camera]

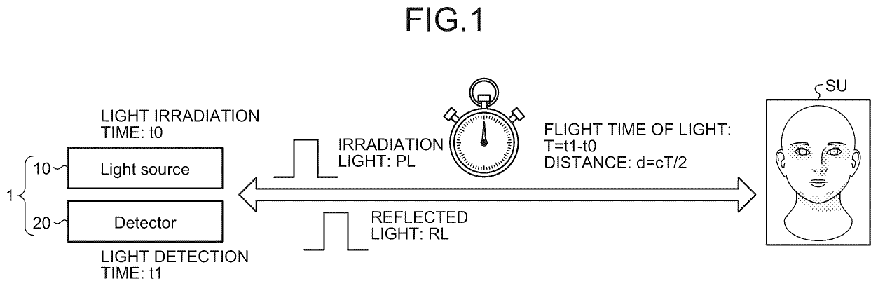

FIG. 1 is an explanatory diagram of a distance measurement method using a ToF camera 1.

The ToF camera 1 includes a light projection unit 10 and a light reception unit 20. The light projection unit 10 projects reference light PL toward a subject SU. The reference light PL is, for example, pulsed light of infrared rays. The light reception unit 20 receives the reference light PL (reflected light RL) reflected by the subject SU. The ToF camera 1 detects the depth d of the subject SU on the basis of the time T from when the reference light PL is projected until the reference light PL is reflected by the subject SU and received by the light reception unit 20. The depth d can be expressed by d=T×c/2 using the light speed c.

Time of flight is directly derived from the deviation of the pulsed light in the time axis direction. The ToF method includes a direc time of flight (dToF) method directly measuring the time of flight from the deviation of the pulsed light and an indirec time of flight (iToF) method indirectly measuring the time of flight on the basis of changes in the phase of the reference light PL, and the dToF method is adopted in the present disclosure.

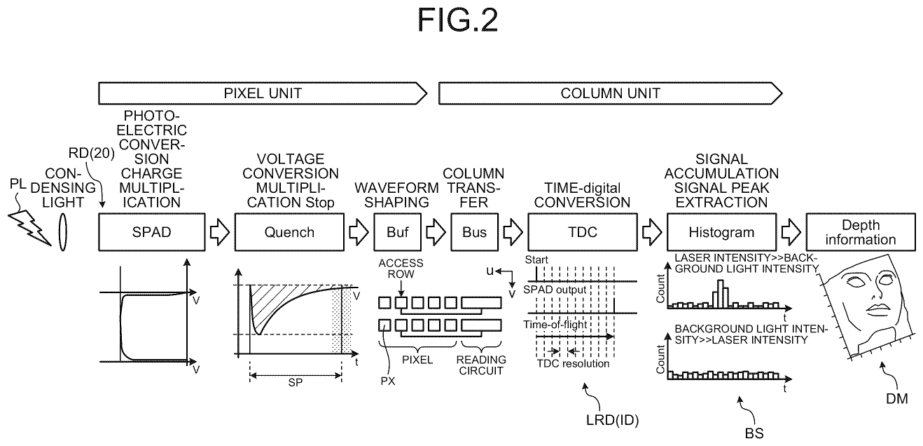

FIG. 2 is a diagram illustrating the outline of the measurement.

The light reception unit 20 includes a plurality of pixels PX arranged in the u direction and the v direction. The direction orthogonal to the arrangement direction of the pixels PX is a depth direction. The pixels PX are provided with infrared sensors that detect infrared rays. The infrared sensor includes, for example, a light receiving device RD using an avalanche photo diode (APD) or a single photon avalanche diode (SPAD). The infrared sensor receives infrared rays at a preset sampling period SP. The infrared sensor detects the number of photons received within one sampling period as brightness (digital sampling processing).

The light reception unit 20 repeatedly measures the brightness within a preset measurement period (one frame). Time is converted to a digital signal by time-digital conversion. The ToF camera 1 stores light reception data LRD of one measurement period measured by the light reception unit 20 as LiDAR input data ID. The LiDAR input data ID is time-series brightness data of each pixel PX measured in one measurement period.

The ToF camera 1 extracts a brightness signal BS for each pixel PX from the LiDAR input data ID. The brightness signal BS is a signal (histogram of brightness for each time) indicating a temporal change in brightness with the vertical axis representing brightness and the horizontal axis representing time. The ToF camera 1 converts time from the measurement start time into a distance (depth). The ToF camera 1 generates a depth map DM of the subject SU on the basis of the LiDAR input data ID.

[2. Degradation Model of Reference Light PL]

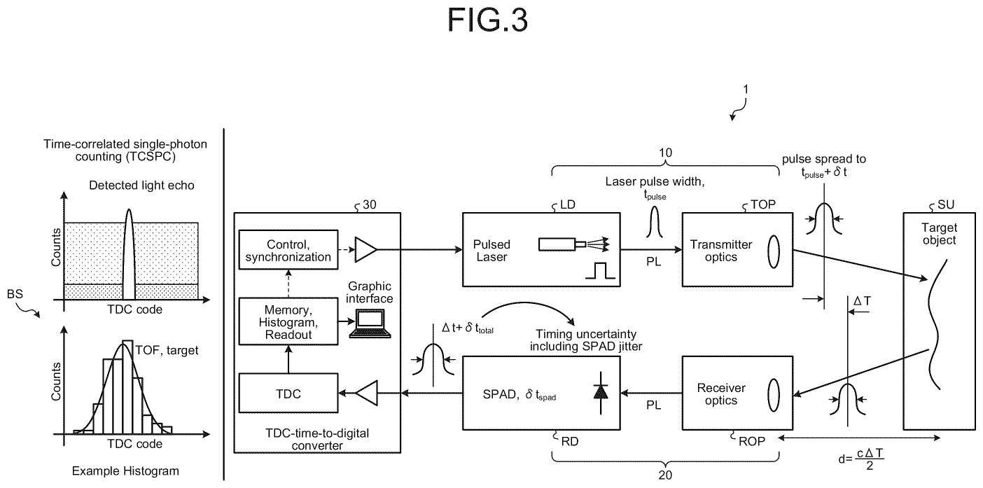

FIG. 3 is a diagram for explaining a degradation model of reference light PL.

At the time of measurement, degradation of the reference light PL may occur on the basis of various factors. For example, the reference light PL output from a light source LD is incident on the light receiving device RD via a transmission optical system TOP, the subject SU, and a reception optical system ROP. When the positions of the lenses of the transmission optical system TOP and the reception optical system ROP are shifted, a waveform of the reference light PL received spreads, and a jitter occurs in the signal waveform of the light receiving device RD. As a result, distortion in the time axis direction (depth direction) occurs in the brightness signal BS extracted by a processing unit 30 from the LiDAR input data ID.

In general, it is desirable to remove such distortion in the signal waveform. However, the present inventor has found that degradation (analog degradation) of the reference light PL in an analog state before being subjected to the digital sampling processing is useful for avoiding restrictions (sampling speed, saturation of brightness signal BS at the time of sampling, and the like) on a device side at the time of AD conversion. According to the study of the present inventor, it has been clear that the resolution of the depth is enhanced by actively analog-degrading the reference light PL and restoring the data using an inverse characteristic of a degradation characteristic after the digital sampling processing rather than using the reference light PL without degradation. Therefore, the present disclosure proposes a method for estimating a depth with high accuracy by combining the analog degradation of the reference light PL and restoration processing. Hereinafter, details will be described.

[3. Mechanism for Improving Depth Resolution by Analog Degradation and Restoration Processing.

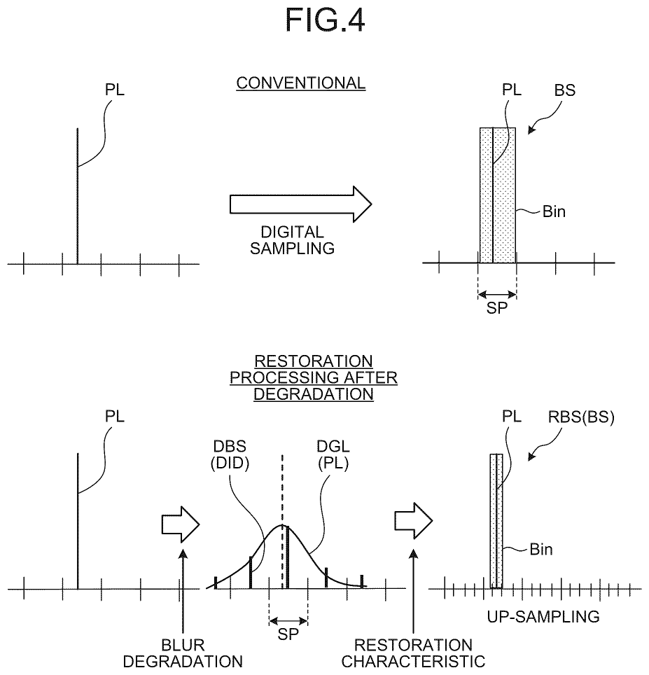

FIG. 4 is a diagram for explaining a mechanism for improving depth resolution by the analog degradation and the restoration processing.

As described above, the light reception unit 20 samples the reference light PL reflected by the subject SU in the sampling period SP. In the conventional configuration illustrated in the upper part of FIG. 4, the reference light PL is incident on the light reception unit 20 as pulsed light (non-degraded light) having a width narrower than the sampling period SP in the time axis direction. At which time within the sampling period the reference light PL is incident is not detected. Therefore, the temporal resolution (width of one Bin of the histogram) of the brightness signal BS coincides with the sampling period SP, and the depth resolution also has a length corresponding to the sampling period SP.

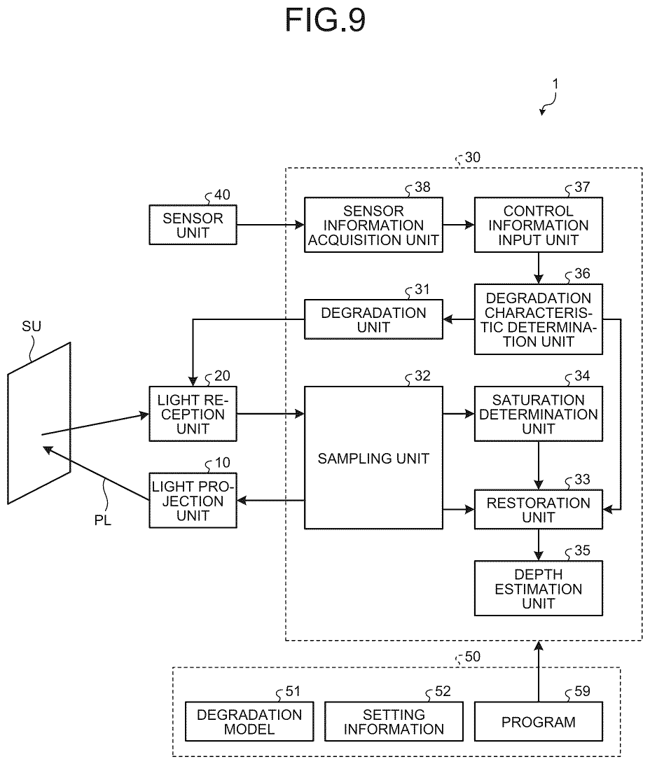

In the method of the present disclosure illustrated in the lower part of FIG. 4, the reference light PL is incident on the light reception unit 20 as broad light (degraded light DGL) having a width wider than the sampling period SP in the time axis direction. For example, the half-value width of the peak caused by the degraded light DGL of the brightness signal BS (degraded brightness signal DBS) extracted from the LiDAR input data ID is twice or more the sampling period SP. The waveform of the degraded light DGL is estimated on the basis of a known degradation model 51 (see FIG. 9) generated by the analysis in advance. The degradation model 51 is a mathematical model indicating the relationship between a degradation factor that affects the waveform of the reference light PL and a change in the waveform of the reference light PL due to the degradation factor. By setting the value of the degradation factor, a degradation characteristic indicating a degradation mode of the reference light PL is determined.

In the present disclosure, the waveform of the reference light PL incident on the light reception unit 20 is widened on the basis of a known degradation characteristic A broad brightness signal BS (degraded brightness signal DBS) is generated by sampling the broad degraded light DGL over a plurality of sampling periods. The LiDAR input data ID obtained by performing the digital sampling processing on the degraded light DGL is degraded light reception data DID including information on the degraded brightness signal DBS of each pixel.

The position of the center of gravity of the degraded brightness signal DBS is accurately obtained on the basis of a gradual temporal change in brightness indicated by the degraded brightness signal DBS. The resolution of the position of the center of gravity is higher than the resolution determined by the sampling period SP. The degraded light DGL subjected to the digital sampling processing is up-sampled as necessary, and then restored using a restoration characteristic that is an inverse characteristic of the degradation characteristic. As a result, the brightness signal BS (restored brightness signal RBS) in which the position of the center of gravity is accurately reproduced is generated.

[4. Saturation Suppression Mechanism by Analog Degradation]

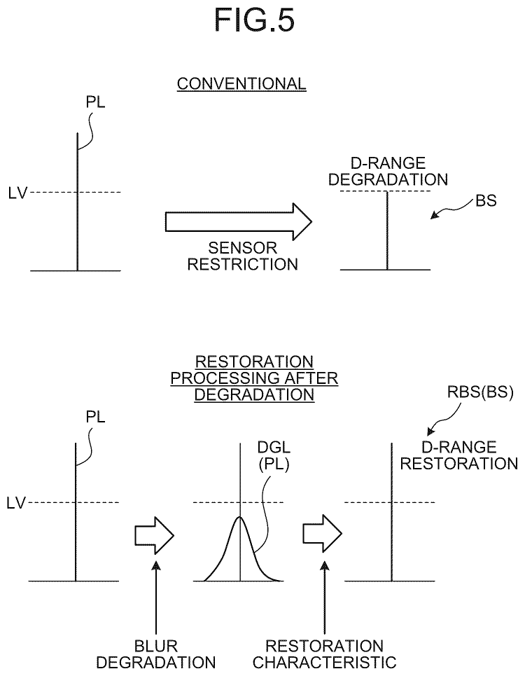

FIG. 5 is a diagram illustrating a saturation suppression mechanism by the analog degradation.

As the light receiving device RD, a highly sensitive light receiving device RD using APD or SPAD is used. The highly sensitive light receiving device RD has a low brightness level (saturation level LV) at which the brightness signal BS is saturated. In the conventional configuration illustrated in the upper part of FIG. 5, the pulse-shaped reference light PL having a large brightness in which energy is aggregated is incident on the light receiving device RD. Therefore, the brightness signal BS is likely to be saturated.

In the configuration of the present disclosure illustrated in the lower part of FIG. 5, the degraded light DGL in which the waveform thereof spreads is incident on the light receiving device RD. Since the energy of the reference light PL is dispersed, the brightness of the degraded light DGL decreases as a whole. Therefore, the brightness signal BS is less likely to be saturated at the time of sampling.

[5. Mechanism for Improving Spatial Resolution]

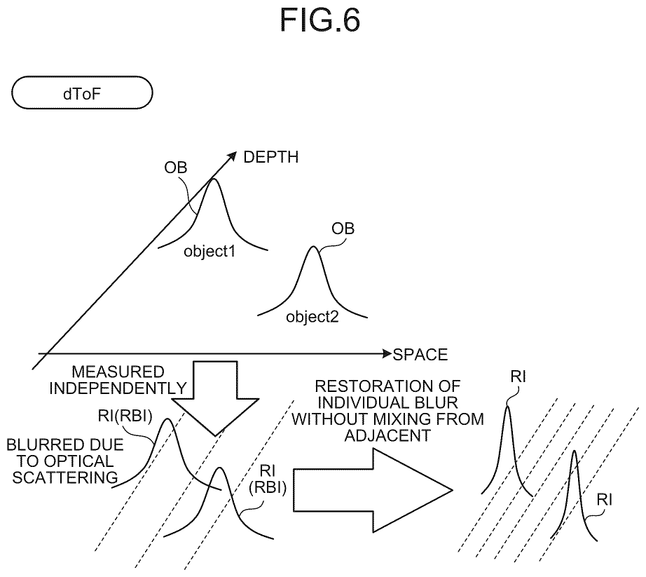

FIG. 6 is a diagram for explaining a mechanism for improving a spatial resolution.

By improving the depth resolution, the resolution in the spatial direction (array direction of the pixels PX) orthogonal to the depth direction is also improved. In the present disclosure, the waveform of the reference light PL is widened, and a light reception image RI of the reference light PL incident on the light receiving device RD is blurred. When observed from a camera viewpoint, the blurred light reception images RI (blurred images BRI) of a plurality of objects OB that are seen through appear to partially overlap. However, in the dToF method, since the subject SU is decomposed in the depth direction, the individual objects OB are independently measured. Mixing of signals in the spatial direction (blurred image BRI) does not occur. Therefore, even if the light reception image RI is blurred, the blur in the spatial direction is accurately eliminated by the restoration processing.

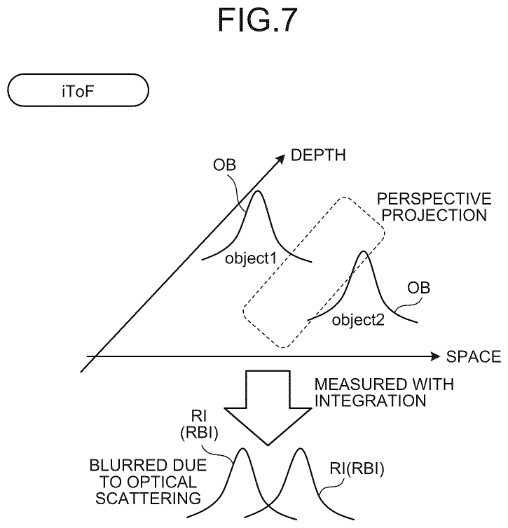

FIG. 7 is, as a comparative example, a diagram illustrating an example in which the iToF method is adopted.

In the iToF method, unlike the dToF method, a blurred portion of the light reception image RI of each object OB is integrated and observed. The signal mixed by the integration is not canceled by the restoration processing. Therefore, new processing for restoring the mixed signal is required.

[6. Outline of Information Processing of ToF Camera]

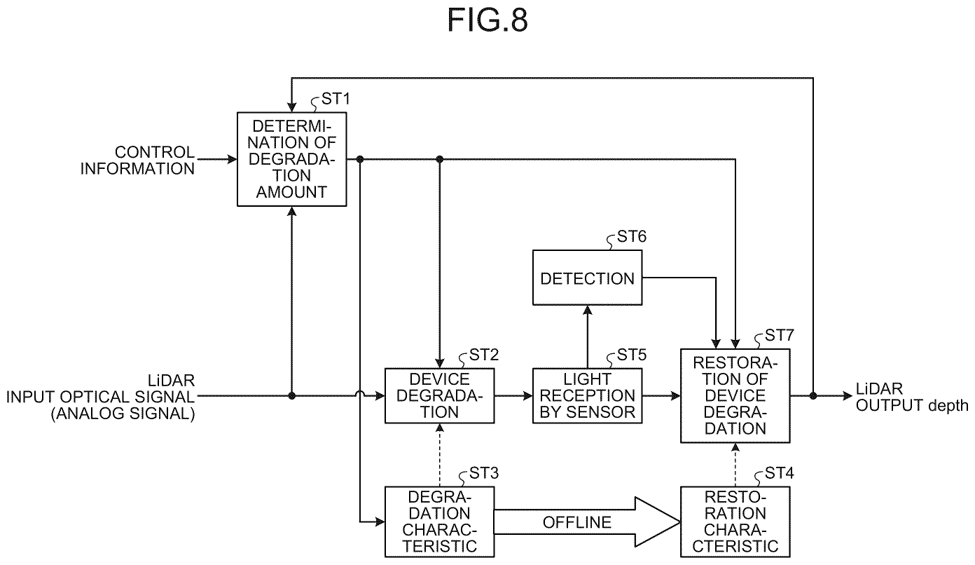

FIG. 8 is a diagram for explaining the outline of information processing of the ToF camera 1.

In Step ST1, the ToF camera 1 determines the value of the degradation factor as a degradation amount on the basis of control information. In Step ST2, the ToF camera 1 intentionally forms device degradation such as a shift of the focal position of the lens according to the degradation amount. In Step ST3, the ToF camera 1 calculates the degradation characteristic on the basis of the degradation amount, and in Step ST4, calculates a restoration characteristic having an inverse characteristic of the degradation characteristic.

In Step ST5, the ToF camera 1 receives the light reception image RI of the subject SU blurred according to the degradation amount as a LiDAR input optical signal. The ToF camera 1 performs digital sampling processing on the LiDAR input optical signal to generate the LiDAR input data ID.

In Step ST6, the ToF camera 1 detects whether or not the LiDAR input data ID includes saturated data with saturated brightness. In Step ST7, the ToF camera 1 restores the LiDAR input data ID on the basis of the restoration characteristic while correcting the saturated data on the basis of unsaturated data that is not saturated. Thereafter, the ToF camera 1 estimates the depth using the restored LiDAR input data ID.

[7. Configuration of ToF Camera]

FIG. 9 is a diagram illustrating a schematic configuration of the ToF camera 1.

The ToF camera 1 includes the light projection unit 10, the light reception unit 20, the processing unit 30, a sensor unit 40, and a storage unit 50.

The light projection unit 10 is, for example, a laser or a projector that projects the reference light PL. The light reception unit 20 is, for example, an image sensor including a plurality of pixels PX for infrared detection. The processing unit 30 is an information processing apparatus that processes various types of information. The processing unit 30 generates a depth map DM on the basis of the LiDAR input data ID acquired from the light reception unit 20. The sensor unit 40 detects various types of information for estimating a situation in which the measurement is performed. The storage unit 50 stores the degradation model 51, setting information 52, and a program 59 necessary for the information processing by the processing unit 30.

The processing unit 30 includes a degradation unit 31, a sampling unit 32, a restoration unit 33, a saturation determination unit 34, a depth estimation unit 35, a degradation characteristic determination unit 36, a control information input unit 37, and a sensor information acquisition unit 38.

The degradation unit 31 widens the waveform of the reference light PL incident on the light reception unit 20 on the basis of the known degradation characteristic. The degradation characteristic is determined in advance by the degradation characteristic determination unit 36. The degradation unit 31 blurs the light reception image RI of the reference light PL received by the light reception unit 20 by widening the waveform of the reference light PL. Examples of the degradation include lens blur and distortion of a waveform in the depth direction (time axis direction) due to distortion of a sampling clock. For example, the degradation unit 31 blurs the light reception image RI by shifting the focal position of the lens included in the reception optical system ROP of the light reception unit 20. The degradation unit 31 calculates the shift amount of the focal position of the lens corresponding to the degradation characteristic, controls a lens drive mechanism included in the light reception unit 20, and shifts the focal position of the lens by the calculated shift amount.

The sampling unit 32 synchronously drives the light projection unit 10 and the light reception unit 20, and samples the degraded light DGL incident on the light reception unit 20 with the sampling period SP. The sampling unit 32 stores the light reception data LRD of one measurement period obtained by the digital sampling processing as the LiDAR input data ID. The LiDAR input data ID generated by the sampling unit 32 is the degraded light reception data DID including information on the degraded brightness signal DBS of each pixel PX. The sampling unit 32 up-samples the degraded light reception data DID as necessary. The sampling unit 32 outputs the generated degraded light reception data DID to the restoration unit 33 and the saturation determination unit 34.

The restoration unit 33 acquires information regarding the degradation characteristic from the degradation characteristic determination unit 36. The restoration unit 33 restores the degraded light reception data DID acquired from the sampling unit 32 using a restoration characteristic that is an inverse characteristic of the degradation characteristic. The depth estimation unit 35 extracts the degraded brightness signal DBS for each pixel PX from the restored degraded light reception data DID. The depth estimation unit 35 converts the time from the measurement start time into a distance (depth) and generates a depth map DM of the subject SU.

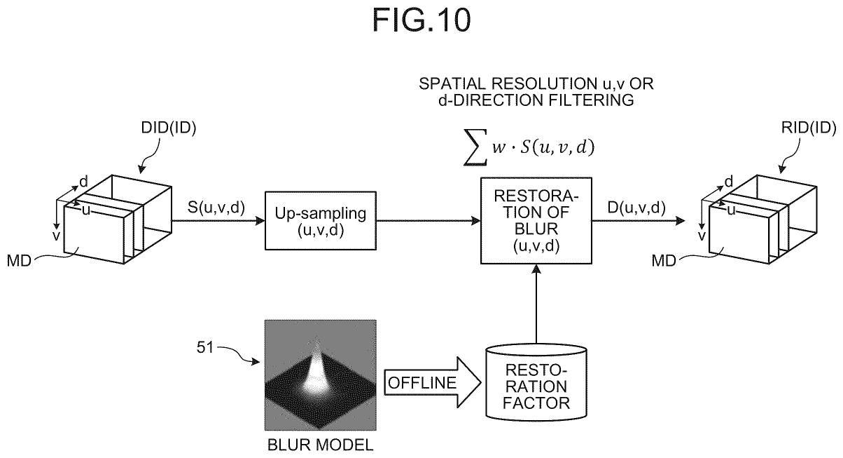

FIG. 10 is a diagram illustrating an example of the restoration processing of the degraded light reception data DID.

The degraded light reception data DID includes ToF data MD at a plurality of times measured in the sampling period SP. The ToF data MD includes data of brightness S (u, v, d) of each pixel PX measured at the same time. The d direction in FIG. 10 indicates the depth direction (time axis direction).

The ToF data MD obtained by sampling the degraded light DGL includes data of the brightness S (u, v, d) indicating the blurred image BRI of the subject SU. The degraded light reception data DID includes data of the blurred image BRI at a plurality of times divided in the depth direction.

As the degradation model 51, a blur model indicating lens blur is used. The blur model is accurately generated using a point spread function or the like. The restoration unit 33 generates a restoration model from the blur model according to the shift of the focal position of the lens. The restoration model is a mathematical model using a restoration factor. By appropriately setting the value of the restoration factor, a restoration characteristic having an inverse characteristic of the degradation characteristic can be obtained.

The restoration unit 33 restores the degraded light reception data DID on the basis of the restoration characteristic and generates restored light reception data RID. As a result, the blur of the light reception image RI is removed from the ToF data MD. The ToF data MD after the restoration includes data of brightness D (u, v, d) indicating the light reception image RI of the subject SU without blur. The restored light reception data RID generated by the restoration processing includes data of the light reception image RI at a plurality of times without blur divided in the depth direction. The depth estimation unit 35 estimates the depth on the basis of the restored light reception data RID.

[8. Example of Improvement of Depth Map by Restoration Processing]

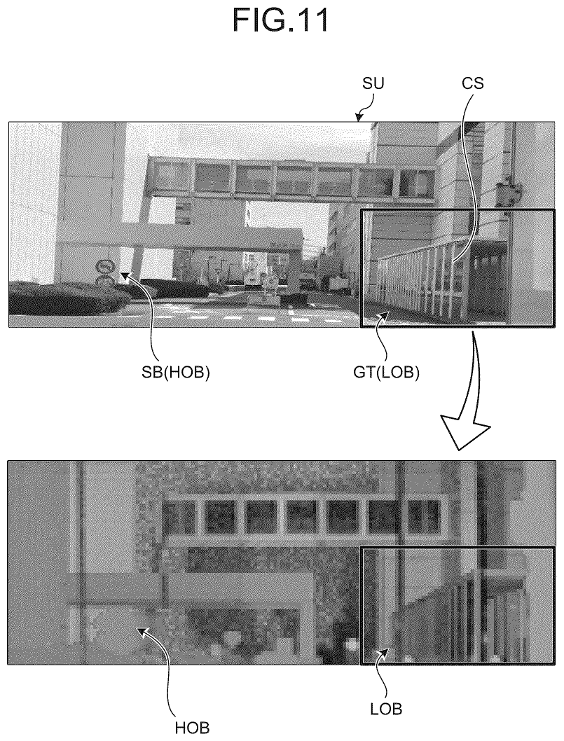

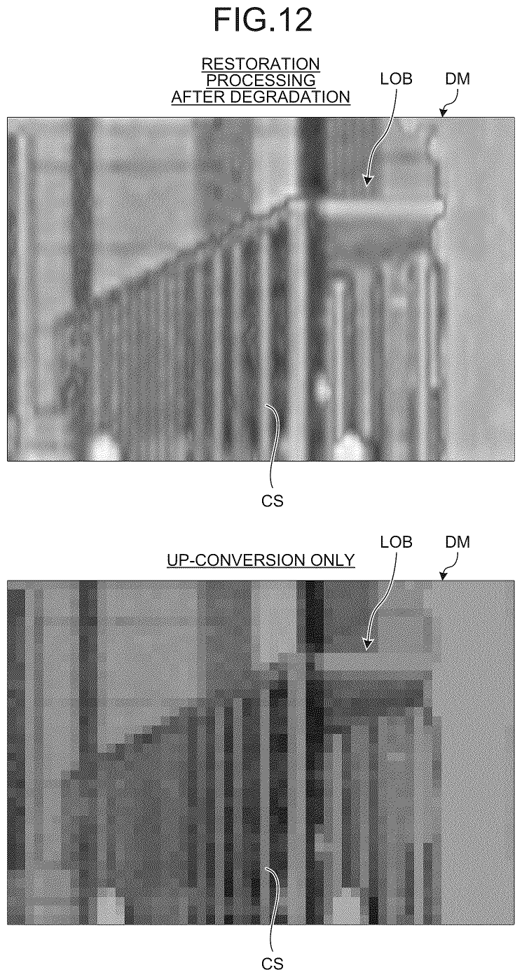

FIGS. 11 and 12 are diagrams illustrating examples of improving the depth map DM by the restoration processing.

The upper part of FIG. 11 is a two-dimensional image of the subject SU. The lower part of FIG. 11 is a diagram illustrating the depth map DM of the subject SU. The subject SU includes a gate GT of a building, a signboard SB, and the like. A plurality of columns CS are arranged in the depth direction at the gate GT. The building includes a plurality of objects having different reflectance. For example, the columns CS are made of metal subjected to surface processing for suppressing glare. Therefore, the columns CS are low reflective objects LOB in which the reflectance of the reference light PL is relatively low. The surface of the signboard SB is subjected to a white coating process. Therefore, the signboard SB is a highly reflective object HOB in which the reflectance of the reference light PL is relatively high.

The lower part of FIG. 12 is a conventional depth map DM of the gate GT without using the above-described degradation and restoration process. In the conventional depth map DM, the boundaries of the columns CS at the back are not clear. Therefore, the number of the columns CS cannot be accurately detected. The spatial resolution of the columns CS on the front side is also low, and it is difficult to recognize the three-dimensional shapes of the column CS. The upper part of FIG. 12 is a depth map DM of the present disclosure of the gate GT using the degradation and restoration process. In the depth map DM of the present disclosure, the boundaries of the columns CS at the back are relatively clear, and the number of columns CS can also be detected substantially accurately. By improving the resolution of the depth, the spatial resolution in the spatial direction orthogonal to the depth direction is also increased. Therefore, the three-dimensional shapes of the columns CS on the front side are easily recognized.

As described above, it can be seen that the depth map DM of the low reflective object LOB such as the columns CS is improved by using the degradation and restoration process of the present disclosure. However, for the highly reflective object HOB such as the signboard SB illustrated in the lower part of FIG. 11, it is difficult to obtain highly accurate depth information due to scattering of the reference light PL and saturation of the brightness signal BS at the time of sampling. Therefore, in the present disclosure, the brightness signal BS around the highly reflective object HOB is corrected (saturation correction) by the saturation determination unit 34 and the restoration unit 33.

[9. Saturation Correction]

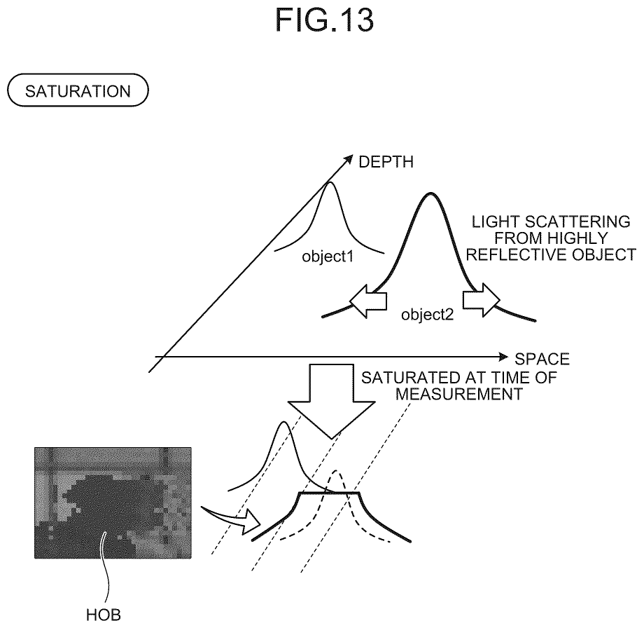

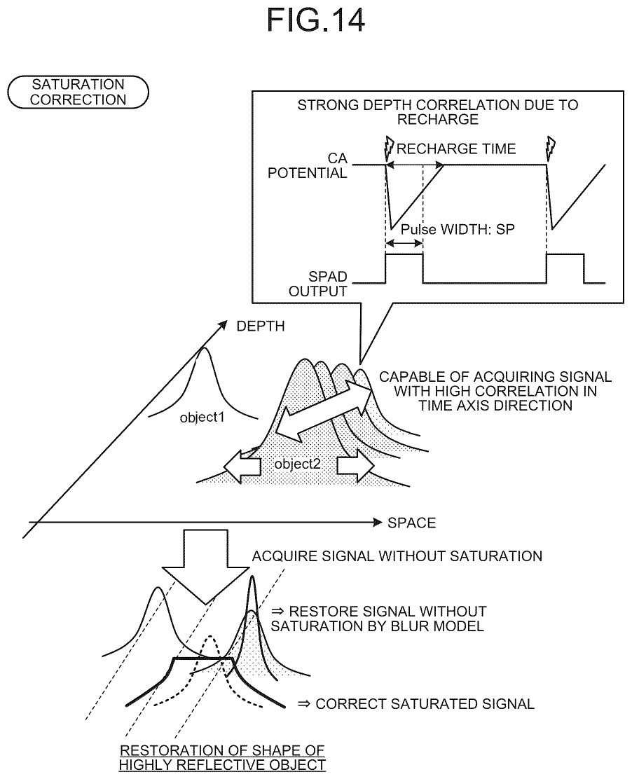

FIGS. 13 and 14 are explanatory diagrams of the saturation correction.

As illustrated in FIG. 13, when the subject SU includes the highly reflective object HOB, the brightness of the image area (object area) of the highly reflective object HOB increases. When the brightness exceeds the saturation level LV, the degraded brightness signal DBS is saturated. In addition, the reference light PL scattered by the highly reflective object HOB is multiple-reflected, whereby the brightness of the image area around the highly reflective object HOB also increases. As a result, a distorted depth map DM in which the contour of the highly reflective object HOB spreads outward is generated. Therefore, as illustrated in FIG. 14, in the present disclosure, the waveform of the saturated degraded brightness signal DBS is corrected using the correlation of the data in the time axis direction based on recharge.

In the light receiving device RD using the APD, the SPAD, or the like, a correlation signal having a high correlation with each other (data of brightness caused by the highly reflective object HOB) is continuously generated in the time axis direction due to the influence of the recharge. The degraded brightness signal DBS acquired from the highly reflective object HOB without multiple reflection includes a correlation signal. No correlation signal is generated in the high brightness image area around the highly reflective object HOB caused by multiple reflection. Therefore, the object area can be estimated on the basis of the presence or absence of the correlation signal. In addition, in the object area, the saturated degraded brightness signal DBS can be corrected on the basis of the unsaturated correlation signal.

For example, the saturation determination unit 34 determines whether or not the degraded light reception data DID includes saturated data with saturated brightness. In a case where it is determined that the degraded light reception data DID includes the saturated data, the restoration unit 33 corrects the saturated data using unsaturated data (correlation signal that is not saturated) at another time correlated with the saturated data in the time axis direction. The restoration unit 33 restores the degraded light reception data DID in which the saturated data is corrected on the basis of the restoration characteristic.

For example, the saturation determination unit 34 extracts the degraded brightness signal DBS for each pixel PX from the restored degraded light reception data DID. On the basis of the degraded brightness signal DBS of each pixel PX, the saturation determination unit 34 determines the presence or absence of brightness data indicating a correlation signal for each pixel PX. For example, in a case where there is a discontinuous temporal change in brightness in the degraded brightness signal DBS, the saturation determination unit 34 determines that the correlation signal is not included. The saturation determination unit 34 determines an image area constituted by the pixels PX in which the correlation signal has been detected to be an object area. The restoration unit 33, in the object area, corrects the saturated degraded brightness signal DBS on the basis of the unsaturated correlation signal.

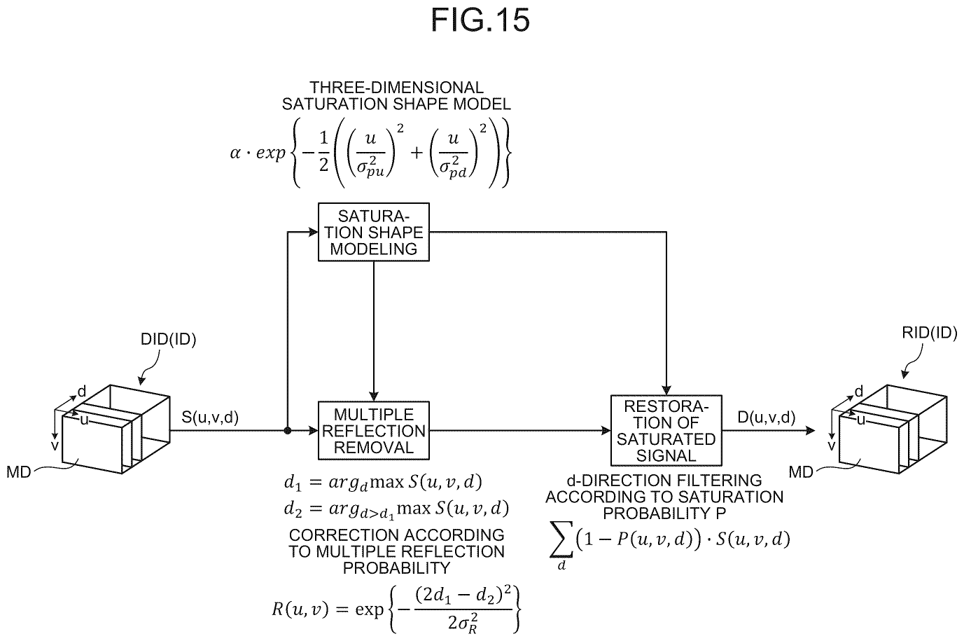

FIG. 15 is a diagram illustrating an example of the saturation correction of the degraded light reception data DID.

The saturation determination unit 34 analyzes the degraded light reception data DID and estimates an object area excluding a high brightness image area caused by multiple reflection (multiple reflection removal). For example, the saturation determination unit 34 detects time (depth) d₁ at which a signal with the maximum brightness (saturated data) is generated from the degraded brightness signal DBS of each pixel PX. In addition, the saturation determination unit 34 detects time d₂ at which a signal with the maximum brightness is generated after the time d₁. The saturation determination unit 34 calculates a probability R (u, v, d) that a correlation signal is included in the degraded brightness signal DBS, using the time du the time d₂, and a variance σ_{R}. The saturation determination unit 34 estimates the object area on the basis of the probability R (u, v, d).

The restoration unit 33 acquires a saturation waveform model of the degraded brightness signal DBS using a variance σₚᵤ and a variance σ_{pd}. The restoration unit 33 calculates a saturation probability P (u, v, d) of the degraded brightness signal DBS extracted from the degraded light reception data DID on the basis of the saturation waveform model. The restoration unit 33 integrates the brightness S (u, v, d) on the basis of the saturation probability P (u, v, d). The restoration unit 33 generates the restored light reception data RID using the brightness D (u, v, d) obtained by the integration. Information regarding various arithmetic models and parameters used for operation such as the probability R (u, v, d) and the saturation probability P (u, v, d) is included in the setting information 52.

[10. Example of Improvement of Depth Map by Saturation Correction]

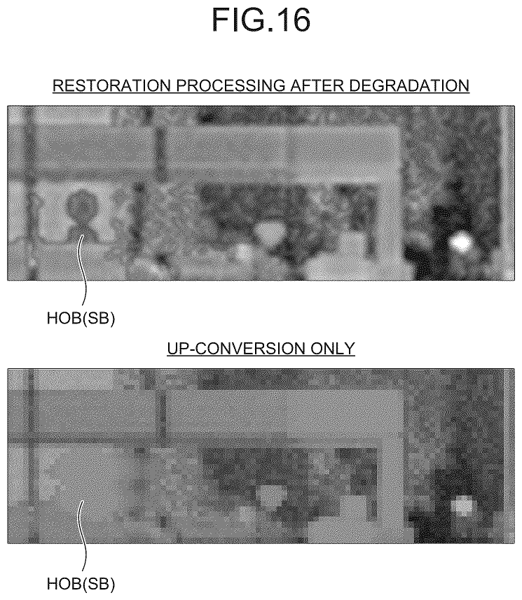

FIG. 16 is a diagram illustrating an example of improving the depth map DM by the saturation correction.

The upper part of FIG. 16 is the depth map DM of the signboard SB using the above-described saturation correction process. The shape of the signboard SB illustrated in the depth map DM substantially matches the shape of the signboard SB illustrated in FIG. 11. As can be seen from a comparison with the depth map DM of the signboard SB at the lower part of FIG. 16, in which the saturation correction is not performed, the influence of saturation and multiple reflection is appropriately removed.

Returning to FIG. 9, the degradation characteristic determination unit 36 determines the degradation characteristic of the reference light PL using the degradation model 51. The degradation characteristic is determined by setting a value of the degradation factor included in the degradation model 51. For example, in a case where the light reception image RI of the reference light PL is blurred by the lens blur, the shift amount of the focal position of the lens is the degradation factor.

The degradation characteristic determination unit 36 determines the degradation characteristic on the basis of the control information input from the control information input unit 37. The control information includes accuracy information indicating required accuracy of the depth and user input information input by the user. For example, the control information input unit 37 estimates a situation in which the measurement is performed on the basis of sensor information input from the sensor information acquisition unit 38. The control information input unit 37 determines the required accuracy of the depth on the basis of the estimated situation. The control information input unit 37 can also determine the required accuracy of the depth required for the next measurement on the basis of the accuracy of the restoration of the degraded light reception data DID performed by the restoration unit 33.

The sensor information acquisition unit 38 acquires the sensor information from the sensor unit 40. The sensor unit 40 includes one or more sensors for detecting a situation in which the measurement is performed. For example, the sensor unit 40 includes a stereo camera, an inertial measurement unit (IMU), an atmospheric pressure sensor, a global positioning system (GPS), a geomagnetic sensor, and the like.

Examples of the situation estimated on the basis of the sensor information include a situation in which highly accurate distance measurement needs to be performed, a situation in which real-time property is required, and the like. In a case where the situation in which the highly accurate distance measurement needs to be performed is detected, the degradation characteristic determination unit 36 determines the degradation characteristic so that the blur of the light reception image RI increases. In this case, since the noise resistance is deteriorated, the sampling unit 32 sets the sampling period SP to a large value. In a case where the real-time property is required, the degradation characteristic determination unit 36 determines the degradation characteristic so that the blur of the light reception image RI decreases, and improves the accuracy within a range that is not easily affected by noise. In this case, since the amount of noise depends on the intensity of external light, it is preferable to adjust the magnitude of blur on the basis of sunlight or weather.

For example, in a case where the ToF camera 1 is mounted on a vehicle, the required accuracy of the depth can be determined on the basis of the moving speed of the vehicle. For example, in a case where the vehicle is moving at a high speed, it is sufficient to find whether or not there is an obstacle, and thus, the degradation characteristic is determined so that the blur amount of the light reception image RI decreases. In a case where the vehicle is slowly driven so as not to collide with each other or in a case where the vehicle is stopped, the degradation characteristic is determined so that the blur amount of the light reception image RI increases, and the highly accurate distance measurement is performed.

The information regarding the above-described various conditions and criteria is included in the setting information 52. The degradation model 51, the setting information 52, and the program 59 used for the above-described processing are stored in the storage unit 50. The program 59 is a program that causes a computer to execute the information processing according to the present embodiment. The processing unit 30 performs various types of processing in accordance with the program 59 stored in the storage unit 50. The storage unit 50 may be used as a work area for temporarily storing a processing result of the processing unit 30. The storage unit 50 includes, for example, any non-transitory storage medium such as a semiconductor storage medium and a magnetic storage medium. The storage unit 50 includes, for example, an optical disk, a magneto-optical disk, or a flash memory. The program 59 is stored in, for example, a non-transitory computer-readable storage medium.

The processing unit 30 is, for example, a computer including a processor and a memory. The memory of the processing unit 30 includes a random access memory (RAM) and a read only memory (ROM). By executing the program 59, the processing unit 30 functions as the degradation unit 31, the sampling unit 32, the restoration unit 33, the saturation determination unit 34, the depth estimation unit 35, the degradation characteristic determination unit 36, the control information input unit 37, and the sensor information acquisition unit 38.

[11. Effects]

The processing unit 30 includes the degradation unit 31, the restoration unit 33, and the depth estimation unit 35. The degradation unit 31 blurs the light reception image RI of the reference light PL received by the light reception unit 20 on the basis of the known degradation characteristic. The restoration unit 33 restores the LiDAR input data (degraded light reception data DID) of the reference light PL using the restoration characteristic that is an inverse characteristic of the degradation characteristic. The depth estimation unit 35 estimates the depth of the subject SU on the basis of the restored LiDAR input data (restored light reception data RID). In the information processing method of the present embodiment, the processing of the processing unit 30 described above is executed by a computer. The program 59 of the present embodiment causes a computer to implement the processing of the processing unit 30 described above.

According to this configuration, since a light reception waveform is broad, the position of the center of gravity of the light reception waveform is accurately detected. By the spread of the light reception waveform in the depth direction (time axis direction), the resolution of the depth becomes higher than the resolution determined by the sampling period SP. By the spread of the light reception waveform, saturation of brightness is less likely to occur. Therefore, decrease in the resolution due to the saturation is also suppressed.

The half-value width of the peak caused by the degraded light DGL of the degraded brightness signal DBS extracted from the LiDAR input data ID is twice or more the sampling period SP of the degraded light DGL.

According to this configuration, the broad degraded light DGL is sampled over a plurality of sampling periods. Therefore, the detection accuracy of the position of the center of gravity of the light reception waveform is enhanced.

The processing unit 30 includes the sampling unit 32. The sampling unit 32 up-samples the degraded light reception data DID. The restoration unit 33 restores the degraded light reception data DID after the up-sampling on the basis of the restoration characteristic.

According to this configuration, the light reception waveform is accurately detected by the up-sampling processing. Therefore, the position of the center of gravity of the light reception waveform is accurately detected.

The processing unit 30 includes the saturation determination unit 34. The saturation determination unit 34 determines whether or not the degraded light reception data DID includes saturated data with saturated brightness. The restoration unit 33 corrects the saturated data using unsaturated data at another time correlated with the saturated data in the time axis direction. The restoration unit 33 restores the degraded light reception data DID in which the saturated data is corrected on the basis of the restoration characteristic.

According to this configuration, the depth of a near view in which the brightness is likely to be saturated is also accurately estimated. Therefore, it is possible to accurately measure the depth over a wide range from a near view to a distant view.

The saturation determination unit 34 extracts the degraded brightness signal DBS for each pixel from the degraded light reception data DID. On the basis of the degraded brightness signal DBS of each pixel, the saturation determination unit 34 determines the presence or absence of brightness data indicating a correlation signal caused by the recharge of the light receiving device RD for each pixel. The saturation determination unit determines an image area constituted by the pixels in which the correlation signal has been detected to be an object area. The restoration unit 33, in the object area, corrects the saturated degraded brightness signal DBS on the basis of the unsaturated correlation signal.

According to this configuration, the estimation accuracy of the depth of the object area is enhanced. Therefore, an accurate depth map of the object reflecting the contour of the object area is generated.

The processing unit 30 includes the control information input unit 37 and the degradation characteristic determination unit 36. The control information input unit 37 inputs control information indicating the required accuracy of the depth. The degradation characteristic determination unit 36 determines the degradation characteristic on the basis of the control information.

According to this configuration, it is possible to perform appropriate measurement according to the required accuracy of the depth.

The control information input unit 37 determines the required accuracy of the depth required for the next measurement on the basis of the accuracy of the restoration of the degraded light reception data DID performed by the restoration unit 33.

According to this configuration, the degradation characteristic is adaptively controlled so that appropriate restoration according to the required accuracy is performed.

The control information input unit 37 estimates a situation in which the measurement is performed on the basis of the sensor information. The control information input unit 37 determines the required accuracy of the depth on the basis of the estimated situation.

According to this configuration, appropriate depth estimation accuracy according to the situation is achieved.

The degradation unit 31 blurs the light reception image RI by shifting the focal position of the lens of the light reception unit 20. The restoration unit 33 restores the degraded light reception data DID on the basis of the restoration characteristic generated from the blur model according to the shift of the focal position of the lens.

According to this configuration, the light reception waveform can be easily adjusted. The blur model is accurately generated by a point spread function or the like. Therefore, high-quality light reception data can be obtained.

Note that the effects described in the present specification are merely examples and are not limited, and other effects may be provided.

[Note]

Note that the present technology can also have the following configurations.

(1)

An information processing apparatus comprising:
a degradation unit that blurs a light reception image of reference light received by a light reception unit on a basis of a known degradation characteristic;
a restoration unit that restores light reception data of the reference light using a restoration characteristic, the restoration characteristic being an inverse characteristic of the degradation characteristic; and
a depth estimation unit that estimates a depth of a subject on a basis of the restored light reception data.
   (2)

The information processing apparatus according to (1),
wherein a half-value width of a peak of a brightness signal extracted from the light reception data caused by the reference light is twice or more a sampling period of the reference light.
   (3)

The information processing apparatus according to (1) or (2),
further comprising a sampling unit that up-samples the light reception data,
wherein the restoration unit restores the up-sampled light reception data on a basis of the restoration characteristic.
   (4)

The information processing apparatus according to any one of (1) to (3),
further comprising a saturation determination unit that determines whether the light reception data includes saturated data in which brightness is saturated,
wherein the restoration unit corrects the saturated data using unsaturated data at another time correlated with saturated data in a time axis direction, and restores the light reception data in which the saturated data is corrected on a basis of the restoration characteristic.
   (5)

The information processing apparatus according to (4),
wherein the saturation determination unit includes:
extracting a brightness signal for each of a plurality of pixels from the light reception data;
determining presence or absence of brightness data indicating a correlation signal caused by recharge of a light receiving device for each pixel on a basis of the brightness signal of each pixel; and
determining an image area constituted by the pixels in which the correlation signal is detected as an object area, and
the restoration unit corrects the saturated brightness signal for the object area on a basis of the unsaturated correlation signal.
   (6)

The information processing apparatus according to any one of (1) to (5),
further comprising a control information input unit that inputs control information indicating required accuracy of depth, and
a degradation characteristic determination unit that determines the degradation characteristic on a basis of the control information.
   (7)

The information processing apparatus according to (6),
wherein the control information input unit determines the required accuracy of the depth required for next measurement on a basis of accuracy of restoration of the light reception data performed by the restoration unit.
   (8)

The information processing apparatus according to (6),
wherein the control information input unit estimates a situation in which measurement is performed on a basis of sensor information, and determines the required accuracy of the depth on a basis of the estimated situation.
   (9)

The information processing apparatus according to any one of (1) to (8),
wherein the degradation unit blurs the light reception image by shifting a focal position of a lens of the light reception unit, and
the restoration unit restores the light reception data on a basis of the restoration characteristic generated from a blur model according to the shift of the focal position of the lens.
   (10)

An information processing method executed by a computer, the method comprising:
blurring a light reception image of reference light received by a light reception unit on a basis of a known degradation characteristic;
restoring light reception data of the reference light by using a restoration characteristic, the restoration characteristic being an inverse characteristic of the degradation characteristic; and
estimating a depth of a subject on a basis of the restored light reception data.
   (11)

A program for causing a computer to implement:
blurring a light reception image of reference light received by a light reception unit on a basis of a known degradation characteristic;
restoring light reception data of the reference light by using a restoration characteristic, the restoration characteristic being an inverse characteristic of the degradation characteristic; and
estimating a depth of a subject on a basis of the restored light reception data.

### REFERENCE SIGNS LIST

20 LIGHT RECEPTION UNIT
30 PROCESSING UNIT (INFORMATION PROCESSING APPARATUS)
31 DEGRADATION UNIT
32 SAMPLING UNIT
33 RESTORATION UNIT
34 SATURATION DETERMINATION UNIT
35 DEPTH ESTIMATION UNIT
36 DEGRADATION CHARACTERISTIC DETERMINATION UNIT
37 CONTROL INFORMATION INPUT UNIT
59 PROGRAM
BS BRIGHTNESS SIGNAL
LRD LIGHT RECEPTION DATA
PL REFERENCE LIGHT
PX PIXEL
RD LIGHT RECEIVING DEVICE
RI LIGHT RECEPTION IMAGE
SP SAMPLING PERIOD

1. An information processing apparatus comprising:
a degradation unit that blurs a light reception image of reference light received by a light reception unit on a basis of a known degradation characteristic;
a restoration unit that restores light reception data of the reference light using a restoration characteristic, the restoration characteristic being an inverse characteristic of the degradation characteristic; and
a depth estimation unit that estimates a depth of a subject on a basis of the restored light reception data.

2. The information processing apparatus according to claim 1,
wherein a half-value width of a peak of a brightness signal extracted from the light reception data caused by the reference light is twice or more a sampling period of the reference light.

3. The information processing apparatus according to claim 1,
further comprising a sampling unit that up-samples the light reception data,
wherein the restoration unit restores the up-sampled light reception data on a basis of the restoration characteristic.

4. The information processing apparatus according to claim 1,
further comprising a saturation determination unit that determines whether the light reception data includes saturated data in which brightness is saturated,
wherein the restoration unit corrects the saturated data using unsaturated data at another time correlated with saturated data in a time axis direction, and restores the light reception data in which the saturated data is corrected on a basis of the restoration characteristic.

5. The information processing apparatus according to claim 4,
wherein the saturation determination unit includes:
extracting a brightness signal for each of a plurality of pixels from the light reception data;
determining presence or absence of brightness data indicating a correlation signal caused by recharge of a light receiving device for each pixel on a basis of the brightness signal of each pixel; and
determining an image area constituted by the pixels in which the correlation signal is detected as an object area, and
the restoration unit corrects the saturated brightness signal for the object area on a basis of the unsaturated correlation signal.

6. The information processing apparatus according to claim 1,
further comprising a control information input unit that inputs control information indicating required accuracy of depth, and
a degradation characteristic determination unit that determines the degradation characteristic on a basis of the control information.

7. The information processing apparatus according to claim 6,
wherein the control information input unit determines the required accuracy of the depth required for next measurement on a basis of accuracy of restoration of the light reception data performed by the restoration unit.

8. The information processing apparatus according to claim 6,
wherein the control information input unit estimates a situation in which measurement is performed on a basis of sensor information, and determines the required accuracy of the depth on a basis of the estimated situation.

9. The information processing apparatus according to claim 1,
wherein the degradation unit blurs the light reception image by shifting a focal position of a lens of the light reception unit, and
the restoration unit restores the light reception data on a basis of the restoration characteristic generated from a blur model according to the shift of the focal position of the lens.

10. An information processing method executed by a computer, the method comprising:
blurring a light reception image of reference light received by a light reception unit on a basis of a known degradation characteristic;
restoring light reception data of the reference light by using a restoration characteristic, the restoration characteristic being an inverse characteristic of the degradation characteristic; and
estimating a depth of a subject on a basis of the restored light reception data.

11. A program for causing a computer to implement:
blurring a light reception image of reference light received by a light reception unit on a basis of a known degradation characteristic;
restoring light reception data of the reference light by using a restoration characteristic, the restoration characteristic being an inverse characteristic of the degradation characteristic; and
estimating a depth of a subject on a basis of the restored light reception data.
